(19) United States
(12) Patent Application Publication
(10) Pub. No.: US 2008/0107500 A1
(43) Pub. Date: May 8, 2008

(54) Modular punch/binding machine and punching module for the same

(75) Inventors: Li-Ming Cheng, Kaohsiung (TW); Kue-Lin Tsai, Kaohsiung (TW); Shi-Mo Liaw, Kaohsiung (TW)

Correspondence Address: SUGHRUE MION, PLLC, 2100 PENNSYLVANIA AVENUE, N.W., SUITE 800, WASHINGTON, DC, 20037, US

(73) Assignee: ZIPSHADE INDUSTRIAL (B.V.I) CORP.

(21) Appl. No.: 11/592,196

(22) Filed: Nov. 3, 2006

(51) Int. Cl. B42B 9/00; B26D 5/08

(52) U.S. Cl. 412/16; 83/620; 412/38

(57) ABSTRACT

The present invention relates to a modular punch/binding machine and a punching module for the punch/binding machine. The punch/binding machine includes a transmission device, at least one punching module, and a body. The punching module includes an upper die base, a lower die base, two joint elements, and two resilient elements. A plurality of punches is disposed in the upper die base, and the transmission device contacts and drives the upper die base. The lower die base has at least one hole for the punches to pass through. The joint elements are respectively connected to two sides of the upper die base and the lower die base. The resilient elements respectively press against two sides of the upper die base and the lower die base. Thus, the punching module is one module, and when being disassembled, the entire module can be taken out merely by detaching the transmission device.

### BACKGROUND OF THE INVENTION

1. Field of the Invention

The present invention relates to a punch/binding machine for loose-leaf papers and a punching module for the punch/binding machine, and more particularly to a punch mechanism for a modular punch/binding machine for loose-leaf papers and a punching module for the punch/binding machine.

2. Description of the Related Art

Currently, the conventional punch/binding machine for loose-leaf papers usually includes a punch mechanism and a binding mechanism. The punch mechanism includes an input rod, a transmission shaft, a plurality of gears, a plurality of racks, a punch plate, a punch guide device, and a plurality of springs. The input rod is used to receive an external force. The transmission shaft is connected to the input rod, and is driven to drive the gears, the racks, and the punch plate under the external force. The racks are disposed on the punch plate. The punch plate is a movable plate body having a plurality of punches fixed thereon. The punches are used to punch a plurality of holes into papers therebelow through the guiding of the punch guide device. Then, after the external force is released, the springs push the punch plate to the original position.

The conventional punch mechanism of a punch/binding machine for loose-leaf papers has the disadvantages that the input rod, the transmission shaft, the gears, the racks, the punch plate, the punch guide device, and the springs are individually installed. Thus, all the elements must be disassembled and then assembled one by one when the punch plate is in need of repair and replacement, which is quite time consuming.

Therefore, it is necessary to provide a modular punch/binding machine and a punching module for a punch/binding machine to solve the above problems.

### SUMMARY OF THE INVENTION

The present invention is directed to providing a modular punch/binding machine, which comprises a transmission device, at least one punching module, and a body. The transmission device receives an external force. The punching module comprises an upper die base, a lower die base, two joint elements, and two resilient elements. The upper die base has a plurality of punches inside, and the transmission device contacts and drives the upper die base. The lower die base has at least one hole for the punches to pass through. The joint elements are respectively connected to two sides of the upper die base and the lower die base. The resilient elements respectively press against two sides of the upper die base and the lower die base. The body has two bumps for supporting two sides of the lower die base. Thus, the external force drives the transmission device to drive the upper die base to move downward, so as to make the punches pass through the hole of the lower die base. Then, after the external force is released, the resilient elements push the upper die base away from the lower die base.

The present invention has the advantage that the punching module is one module, and when being disassembled (for repairing or replacing the punch), the entire punching module can be taken out by only disassembling the transmission device. As such, the procedure of disassembling is much simpler than that of the conventional punch/binding machine, and the time required for disassembling is significantly reduced.

### BRIEF DESCRIPTION OF THE DRAWINGS

FIG. 1 is a perspective view of a modular punch/binding machine according to the present invention;

FIG. 2 is a perspective, assembled view of a punch mechanism of the modular punch/binding machine according to the present invention;

FIG. 3 is a perspective exploded view of the punch mechanism of the modular punch/binding machine according to the present invention;

FIG. 4 is a side view of a first punching module, a second punching module, and a third punching module of the modular punch/binding machine according to the present invention;

FIG. 5 is a perspective exploded view of the first punching module of the modular punch/binding machine according to the present invention;

FIG. 6 is a perspective exploded view of the second punching module of the modular punch/binding machine according to the present invention;

FIG. 7 is a perspective exploded view of the third punching module of the modular punch/binding machine according to the present invention; and

FIG. 8 is a schematic view of the actuation of the first punching module, the second punching module, and the third punching module of the modular punch/binding machine according to the present invention.

### DETAILED DESCRIPTION OF THE INVENTION

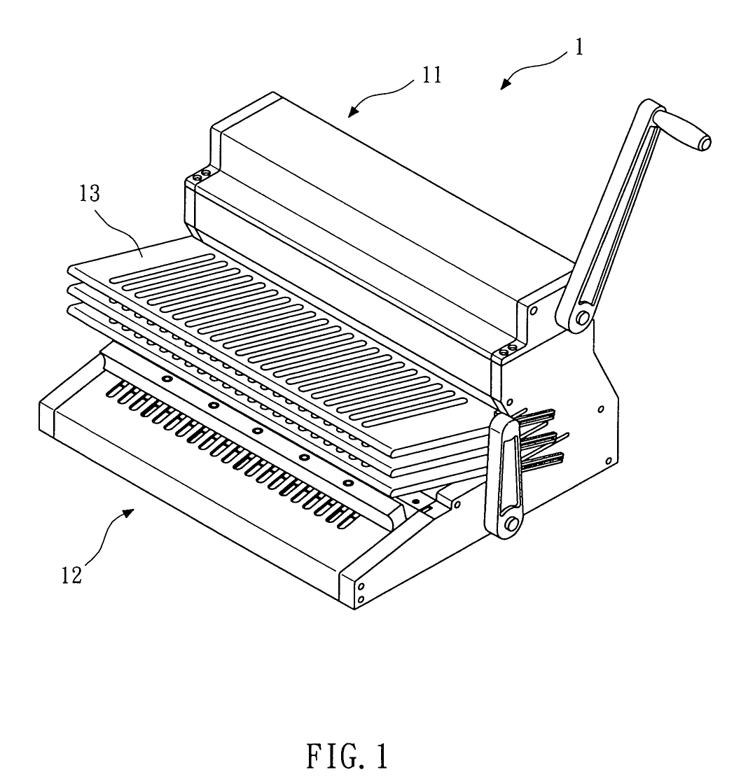

FIG. 1 shows a perspective view of a modular punch/binding machine according to the present invention. The modular punch/binding machine 1 of the present invention includes a punch mechanism 11, a binding mechanism 12, and three paper-feeding trays 13.

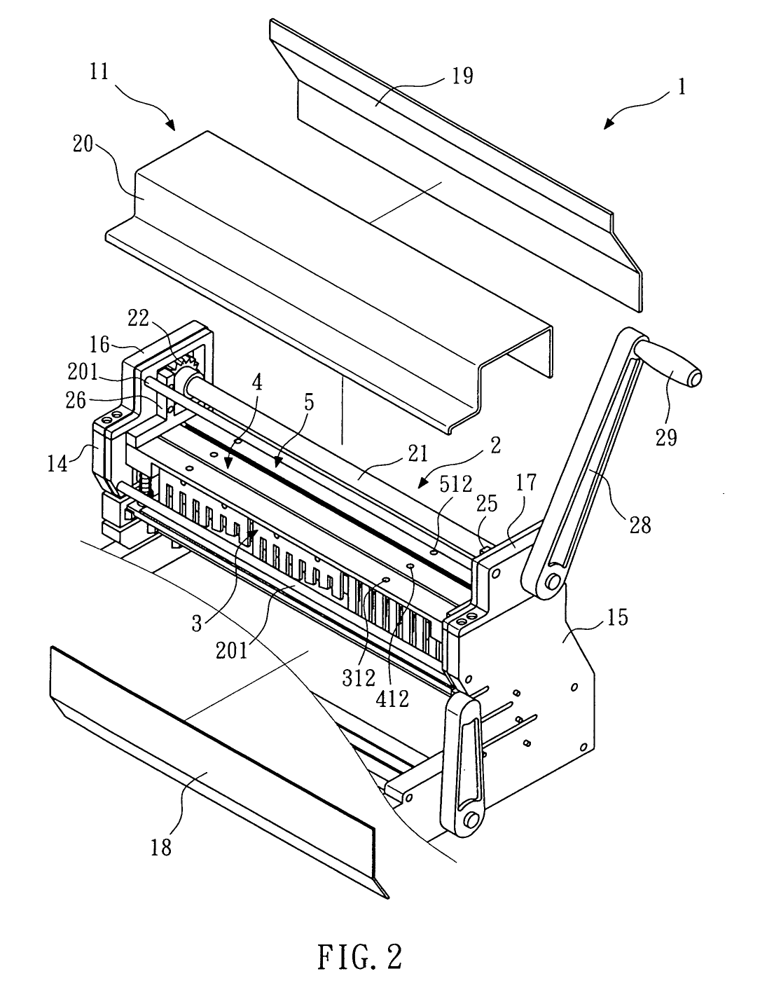

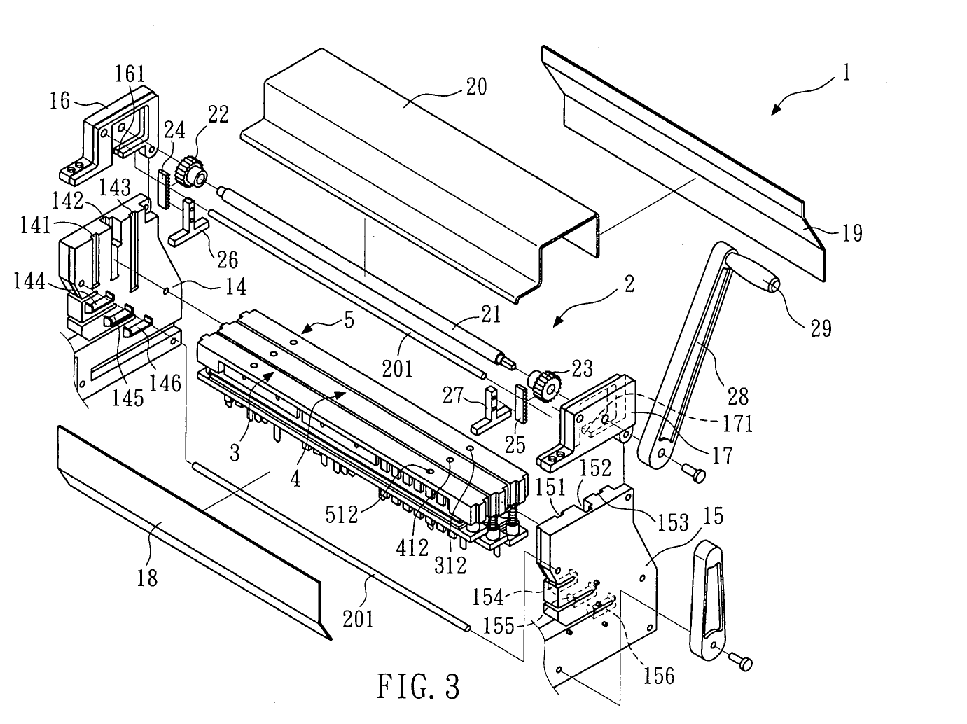

FIG. 2 shows a perspective, assembled view of a punch mechanism of the modular punch/binding machine according to the present invention. FIG. 3 shows a perspective exploded view of the punch mechanism of the modular punch/binding machine according to the present invention. The punch mechanism 11 of the modular punch/binding machine 1 includes a transmission device 2, a first punching module 3, a second punching module 4, a third punching module 5, a body (including a left-side body 14 and a right-side body 15), a left-side upper cover body 16, a right-side upper cover body 17, a front cover plate 18, a back cover plate 19, an upper cover plate 20, and a plurality of positioning rods 201.

The transmission device 2 receives an external force, and includes an input shaft 21, a left input gear 22, a right input gear 23, a left transmission rack 24, a right transmission rack 25, a left T-shaped rod 26, a right T-shaped rod 27, and an input rod 28. The left input gear 22 and the right input gear 23 are fitted on two ends of the input shaft 21, and then the two ends of the input shaft 21 are respectively inserted into the left-side upper cover body 16 and the right-side upper cover body 17, so as to be supported by the left-side upper cover body 16 and the right-side upper cover body 17 respectively. One end of the input rod 28 is secured to one end of the input shaft 21, and the other end of the input rod 28 is pivoted at an input handle 29, so as to receive the external force.

The left transmission rack 24 is secured to the left T-shaped rod 26, and receives the transmission of the left input gear 22. The right transmission rack 25 is secured to the right T-shaped rod 27, and receives the transmission of the right input gear 23. The bottom surfaces of the left T-shaped rod 26 and the right T-shaped rod 27 are in contact with the upper surfaces of the first punching module 3, the second punching module 4, and the third punching module 5.

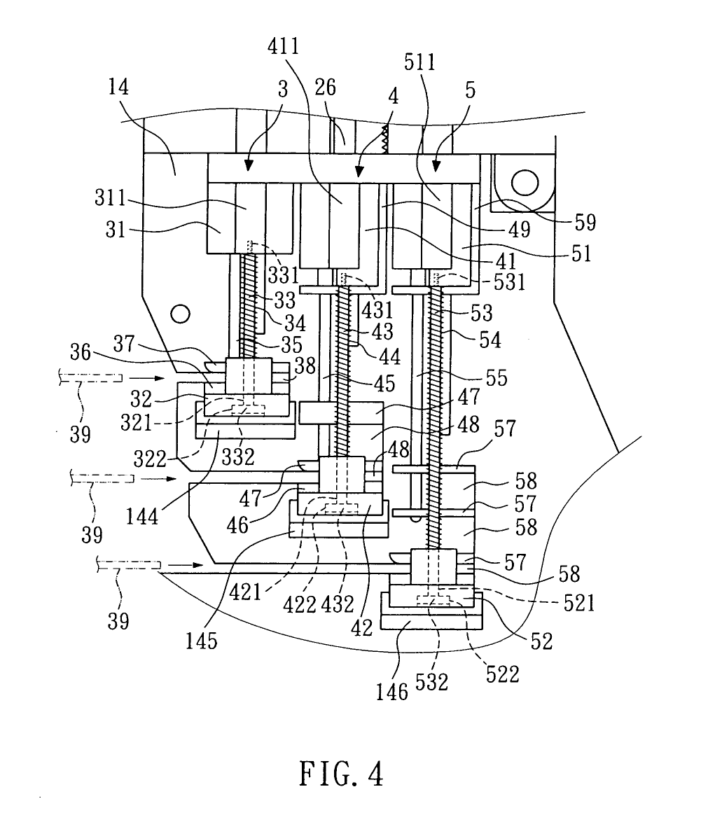

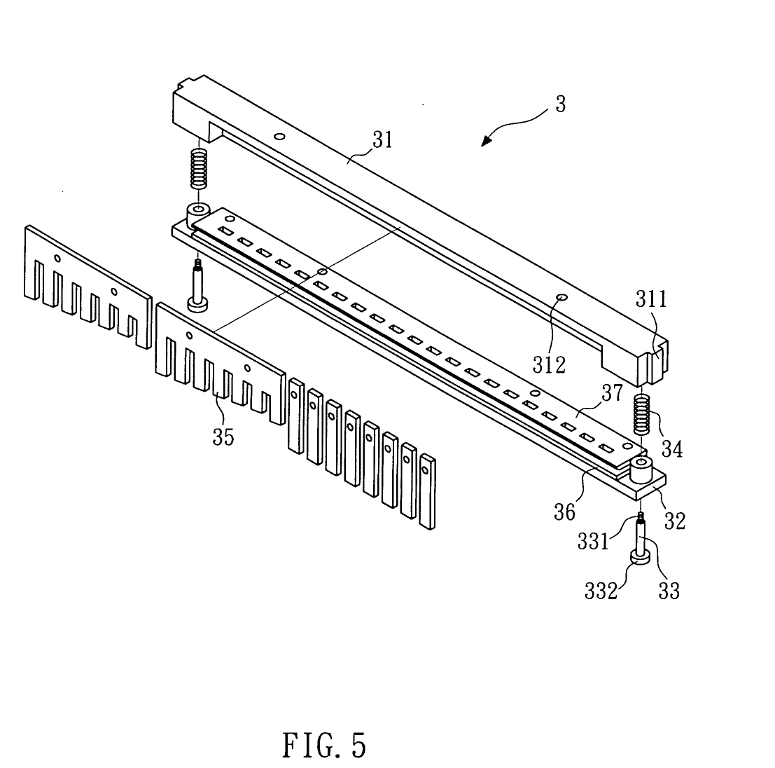

FIG. 4 shows a schematic side view of a first punching module, a second punching module, and a third punching module of the modular punch/binding machine according to the present invention. FIG. 5 shows a perspective exploded view of the first punching module of the modular punch/binding machine according to the present invention. The first punching module 3 includes a first upper die base 31, a first lower die base 32, two first joint elements 33, two first resilient elements 34, a plurality of first punches 35, a first lower die 36, a first punch guide plate 37, and a first securing element 38. The first upper die base 31 has the first punches 35 inside, and the first upper die base 31 further includes two first protrusions 311 and two screw holes 312, and the first protrusions 311 are located at two ends of the first upper die base 31. The screw holes 312 are located on the upper surface of the first upper die base 31 for screwing in a bolt, such that it is convenient to take out the first punching module 3. However, in another application, more than one bump or handle can be disposed on the upper surface of the first upper die base 31, which is also convenient for taking out the first punching module 3. In this embodiment, the first punches 35 are square-shaped, and are locked on the first upper die base 31, and thus only a specific first punch 35 is replaced. The lengths of the first punches 35 are not the same, so as to prevent the tearing of paper sheets 39 when being punched, and save the external force for punching. The bottom surfaces of the left T-shaped rod 26 and the right T-shaped rod 27 of the transmission device 2 (FIG. 2) are in contact with the upper surface of the first upper die base 31, and drive the first upper die base 31.

The first lower die base 32 has at least one hole (not shown) for the first punches 35 to pass through. The first lower die base 32 has a first upper groove 321 and a first lower groove 322 respectively on two sides thereof, and the area of the first upper groove 321 is less than that of the first lower groove 322. The first joint elements 33 are respectively connected to two sides of the first upper die base 31 and the first lower die base 32. In this embodiment, the first joint element 33 is a bolt with one end being a threaded portion 331 and the other end being a head portion 332. The first joint element 33 passes through the first lower groove 322 and the first upper groove 321 and is locked on the first upper die base 31 by using the threaded portion 331. The first joint element 33 is movable in the first upper groove 321 and the first lower groove 322 of the first lower die base 32.

The first resilient elements 34 respectively press against two sides of the first upper die base 31 and the first lower die base 32. In this embodiment, the first resilient element 34 is a spring, and each of the first resilient elements 34 surrounds each of the first joint elements 33.

The first lower die 36 has a plurality of holes corresponding to the first punches 35. The first punch guide plate 37 has a plurality of holes corresponding to the first punches 35. The first lower die 36 is fixed on the first lower die base 32, and the first punch guide plate 37 is fixed on the first lower die 36 through the first securing element 38 (e.g., a plate or a plurality of short pillars). The first securing element 38 pushes the first punch guide plate 37 away from the first lower die 36 to a certain distance in order to insert the paper sheets 39.

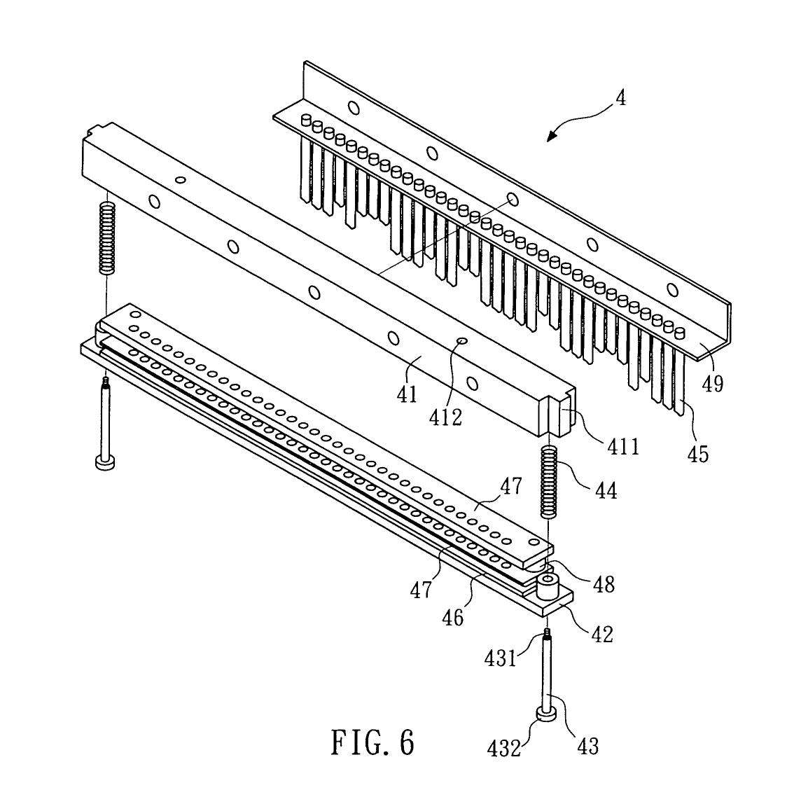

FIG. 6 shows a perspective exploded view of the second punching module of the modular punch/binding machine according to the present invention. The second punching module 4 includes a second upper die base 41, a second lower die base 42, two second joint elements 43, two second resilient elements 44, a plurality of second punches 45, a second lower die 46, two second punch guide plates 47, a plurality of second securing elements 48, and a second punch seat 49. The second upper die base 41 further includes two second protrusions 411 and two screw holes 412. The second protrusions 411 are located at two ends of the second upper die base 41. The screw holes 412 are located on the upper surface of the second upper die base 41 respectively for screwing in a bolt, such that it is convenient to take out the second punching module 4. However, in another application, more than one bump or handle can be disposed on the upper surface of the second upper die base 41, which is also convenient for taking out the second punching module 4. In this embodiment, the second punches 45 are round-shaped, and the second punch seat 49 has a plurality of holes corresponding to the second punches 45. After the second punches 45 are inserted into the holes, the second punch seat 49 is locked on the second upper die base 41, such that the second punches 45 are disposed in the second upper die base 41. Therefore, only a specific second punch 45 is replaced. The lengths of the second punches 45 are not the same, so as to prevent the tearing of the paper sheets 39 when being punched, and save the external force for punching. The bottom surfaces of the left T-shaped rod 26 and the right T-shaped rod 27 of the transmission device 2 (FIG. 2) are in contact with the upper surface of the second upper die base 41, and drive the second upper die base 41.

The second lower die base 42 has at least one hole (not shown) for the second punches 45 to pass through. Referring to FIG. 4 and FIG. 6 together, the second lower die base 42 has a second upper groove 421 and a second lower groove 422 respectively on two sides thereof, and the area of the second upper groove 421 is less than that of the second lower groove 422. The second joint elements 43 are respectively connected to two sides of the second upper die base 41 and the second lower die base 42. In this embodiment, the second joint element 43 is a bolt with one end being a threaded portion 431 and the other end being a head portion 432. The second joint element 43 passes through the second lower groove 422 and the second upper groove 421 and is locked on the second upper die base 41 by using the threaded portion 431. The second joint element 43 is movable in the second upper groove 421 and the second lower groove 422 of the second lower die base 42.

The second resilient elements 44 respectively press against two sides of the second upper die base 41 and the second lower die base 42. In this embodiment, the second resilient element 44 is a spring, and each of the second resilient elements 44 surrounds each of the second joint elements 43.

The second lower die 46 has a plurality of holes corresponding to the second punches 45. The second punch guide plates 47 have a plurality of holes corresponding to the second punches 45. The second lower die 46 is fixed on the second lower die base 42. The second punch guide plates 47 are fixed on the second lower die 46 through the second securing elements 48 (e.g., a plate or a plurality of short pillars). The second securing elements 48 respectively push the second punch guide plates 47 away from the second lower die 46 to a certain distance, and the lowermost space is used for inserting the paper sheets 39.

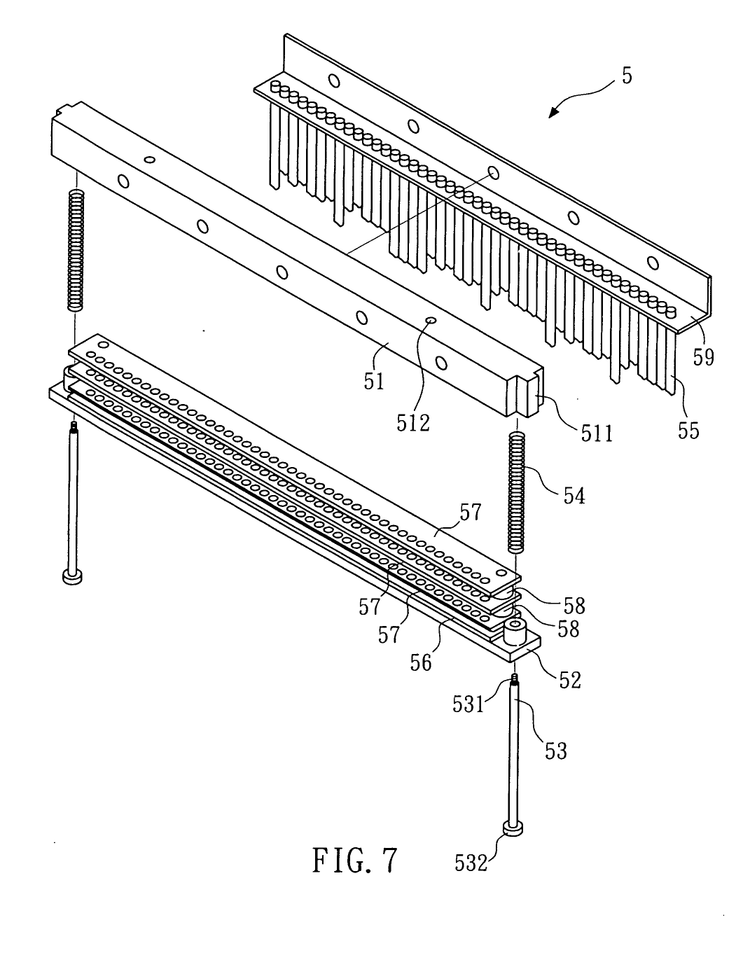

FIG. 7 shows a perspective exploded view of the third punching module of the modular punch/binding machine according to the present invention. The third punching module 5 includes a third upper die base 51, a third lower die base 52, two third joint elements 53, two third resilient elements 54, a plurality of third punches 55, a third lower die 56, three third punch guide plates 57, a plurality of second securing elements 58, and a third punch seat 59. The third upper die base 51 further includes two third protrusions 511 and two screw holes 512. The third protrusions 511 are located at two ends of the third upper die base 51. The screw holes 512 are located on the upper surface of the third upper die base 51 respectively for screwing in a bolt, such that it is convenient for taking out the third punching module 5. However, in another application, more than one bump or handle can be disposed on the upper surface of the third upper die base 51, which is also convenient for taking out the third punching module 5. In this embodiment, the third punches 55 are round-shaped, and the third punch seat 59 has a plurality of holes corresponding to the third punches 55. After the third punches 55 are inserted into the holes, the third punch seat 59 is locked on the third upper die base 51, such that a plurality of third punches 55 is disposed in the third upper die base 51, and thus only a specific third punch 55 is replaced. Unlike the second punches 45, the third punches 55 are densely arranged. The lengths of the third punches 55 are not the same, so as to prevent the tearing of paper sheets 39 when being punched, and save the external force for punching. The bottom surfaces of the left T-shaped rod 26 and the right T-shaped rod 27 of the transmission device 2 (FIG. 2) are in contact with the upper surface of the third upper die base 51, and drive the third upper die base 51.

The third lower die base 52 has at least one hole (not shown) for the third punches 55 to pass through. Referring to FIG. 4 and FIG. 7 together, the third lower die base 52 has a third upper groove 521 and a third lower groove 522 on two sides thereof, and the area of the third upper groove 521 is less than that of the third lower groove 522. The third joint elements 53 are respectively connected to two sides of the third upper die base 51 and the third lower die base 52. In this embodiment, the third joint element 53 is a bolt with one end being a threaded portion 531 and the other end being a head portion 532. The third joint element 53 passes through the third lower groove 522 and the third upper groove 521 and is locked on the third upper die base 51 by using the threaded portion 531. The third joint element 53 is movable in the third upper groove 521 and the third lower groove 522 of the third lower die base 52.

The third resilient elements 54 respectively press against two sides of the third upper die base 51 and the third lower die base 52. In this embodiment, the third resilient element 54 is a spring, and each of the third resilient elements 54 surrounds each of the third joint elements 53.

The third lower die 56 has a plurality of holes corresponding to the third punches 55. The third punch guide plates 57 have a plurality of holes corresponding to the third punches 55. The third lower die 56 is fixed on the third lower die base 52. The third punch guide plates 57 are fixed on the third lower die 56 through the third securing elements 58 (e.g., a plate or a plurality of short pillars). The third securing elements 58 respectively push the third punch guide plates 57 away from the third lower die 56 to a certain distance, and the lowermost space is used for inserting the paper sheets 39.

Referring to FIG. 2 and FIG. 3 again, the left-side upper cover body 16 is fixed on the left-side body 14, and the right-side upper cover body 17 is fixed on the right-side body 15. The left-side upper cover body 16 further includes a left groove 161 for the left transmission rack 24 to slide therein, and the right-side upper cover body 17 further includes a right groove 171 for the right transmission rack 25 to slide therein. The left-side body 14 has a first sliding slot 141, a second sliding slot 142, a third sliding slot 143, a first bump 144, a second bump 145, and a third bump 146. Similarly, the right-side body 15 has a first sliding slot 151, a second sliding slot 152, a third sliding slot 153, a first bump 154, a second bump 155, and a third bump 156.

The first sliding slots 141, 151 are used for the first protrusion 311 of the first upper die base 31 to slide therein. The second sliding slots 142, 152 are used for the second protrusion 411 of the second upper die base 41 to slide therein, and can also be used for the left transmission rack 24 and the right transmission rack 25 to slide therein. The third sliding slots 143, 153 are used for the third protrusion 511 of the third upper die base 51 to slide therein. The first bumps 144, 154 are used to support two sides of the first lower die base 32, the second bumps 145, 155 are used to support two sides of the second lower die base 42, and the third bumps 146, 156 are used to support two sides of the third lower die base 52.

The front cover plate 18, the back cover plate 19, and the upper cover plate 20 are used to cover the space between the left-side upper cover body 16, the right-side upper cover body 17, the left-side body 14, and the right-side body 15. The positioning rods 201 are used for positioning during assembly, and for reinforcing the structural strength of the punch/binding machine.

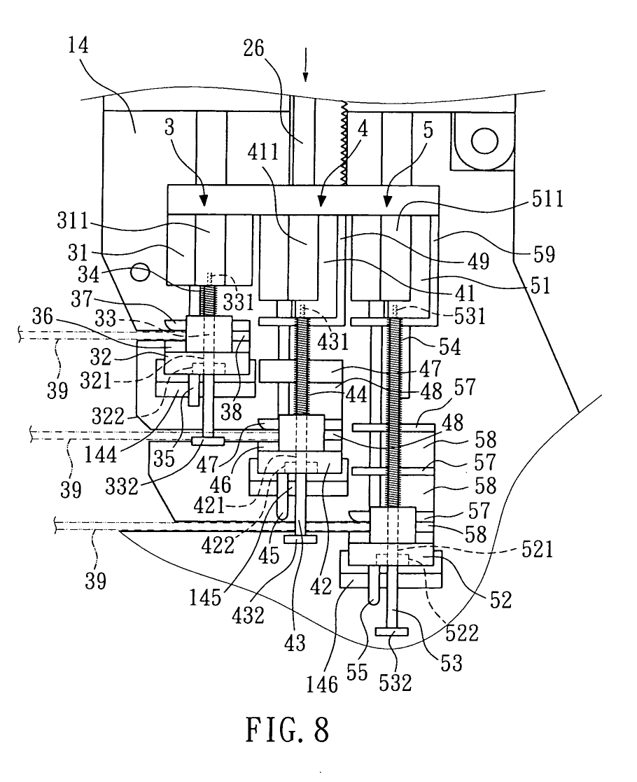

The actuation manner of the present invention is illustrated as below. Referring to FIG. 2, the user exerts an external force on the input handle 29 to rotate the input rod 28. Then, the input rod 28 drives the input shaft 21, and simultaneously drives the left input gear 22, the right input gear 23, the left transmission rack 24, and the right transmission rack 25, thereby driving the left T-shaped rod 26 and the right T-shaped rod 27 to press down the first upper die base 31, the second upper die base 41, and the third upper die base 51. Referring to FIG. 4, the left T-shaped rod 26 and the right T-shaped rod 27 press down the first upper die base 31, the second upper die base 41, and the third upper die base 51 and move downward together, such that the first punches 35 pass through the holes of the first lower die base 32, the second punches 45 pass through the holes of the second lower die base 42, and the third punches 55 pass through the holes of the third lower die base 52, so as to perform a punching operation on the paper sheets 39, as shown in FIG. 8. After the external force is released, the first resilient elements 34 push the first upper die base 31 away from the first lower die base 32, the second resilient elements 44 push the second upper die base 41 away from the second lower die base 42, and the third resilient elements 54 push the third upper die base 51 away from the third lower die base 52, thus returning to the state as shown in FIG. 4.

The present invention has the advantage that the first punching module 3, the second punching module 4, and third punching module 5 are respectively one module. When being disassembled (e.g., for repairing or replacing the punch), the first punching module 3, the second punching module 4, or the third punching module 5 can be entirely taken out merely by lifting the upper cover plate, taking the left-side upper cover body 16 from the left-side body 14, taking the right-side upper cover body 17 from the right-side body 15, and removing the input shaft 21, the left input gear 22, the right input gear 23, the left transmission rack 24, the right transmission rack 25, the left T-shaped rod 26, the right T-shaped rod 27, and the input rod 28. As such, the procedure of disassembling is much simpler than that of the conventional punch/binding machine, and the time required for disassembling is significantly reduced.

While several embodiments of the present invention have been illustrated and described, various modifications and improvements can be made by those skilled in the art. The embodiments of the present invention are therefore described in an illustrative but not restrictive sense. It is intended that the present invention may not be limited to the particular forms as illustrated, and that all modifications which maintain the spirit and scope of the present invention are within the scope as defined in the appended claims.

What is claimed is:

1. A modular punch/binding machine, comprising:
a transmission device, for receiving an external force;
at least one punching module, comprising:
an upper die base, having a plurality of punches disposed therein, wherein the transmission device contacts and drives the upper die base;
a lower die base, having at least one hole for the punches to pass through;
two joint elements, respectively connected to two sides of the upper die base and the lower die base; and
two resilient elements, respectively pressing against two sides of the upper die base and the lower die base; and
a body, having two bumps for supporting two sides of the lower die base;
whereby the external force drives the transmission device to drive the upper die base to move downward, such that the punches pass through the hole of the lower die base, and then after the external force is released, the resilient elements push the upper die base away from the lower die base.

2. The punch/binding machine as claimed in claim 1, further comprising a left-side upper cover body and a right-side upper cover body, wherein the body comprises a left-side body and a right-side body, the left-side upper cover body is fixed on the left-side body, and the right-side upper cover body is fixed on the right-side body.

3. The punch/binding machine as claimed in claim 2, wherein the transmission device comprises an input shaft, a left input gear, a right input gear, a left transmission rack, a right transmission rack, a left T-shaped rod, a right T-shaped rod and an input rod, the left input gear and the right input gear are fitted on two ends of the input shaft, the two ends of the input shaft are respectively supported by the left-side upper cover body and the right-side upper cover body, one end of the input rod is secured to one end of the input shaft, and the other end of the input rod receives the external force, the left transmission rack is secured to the left T-shaped rod and receives the transmission of the left input gear, the right transmission rack is secured to the right T-shaped rod and receives the transmission of the right input gear, and the bottom surfaces of the left T-shaped rod and the right T-shaped rod are in contact with the upper surface of the upper die base.

4. The punch/binding machine as claimed in claim 3, wherein the left-side upper cover body further comprises a left groove for the left transmission rack to slide therein, and the right-side upper cover body further comprises a right groove for the right transmission rack to slide therein.

5. The punch/binding machine as claimed in claim 2, further comprising an upper cover plate for covering the space between the left-side upper cover body and the right-side upper cover body.

6. The punch/binding machine as claimed in claim 1, wherein the transmission device comprises an input shaft, a left input gear, a right input gear, a left transmission rack, a right transmission rack, a left T-shaped rod, a right T-shaped rod and an input rod, the left input gear and the right input gear are fitted on two ends of the input shaft, one end of the input rod is secured to one end of the input shaft, and the other end of the input rod receives the external force, the left transmission rack is secured to the left T-shaped rod and receives the transmission of the left input gear, the right transmission rack is secured to the right T-shaped rod and receives the transmission of the right input gear, and the bottom surfaces of the left T-shaped rod and the right T-shaped rod are in contact with the upper surface of the upper die base.

7. The punch/binding machine as claimed in claim 1, wherein the punching module further comprises a lower die, a punch guide plate, and a securing element, the lower die has a plurality of holes corresponding to the punches, the punch guide plate has a plurality of holes corresponding to the punches, the lower die is disposed on the lower die base, and the punch guide plate is fixed on the lower die through the securing element.

8. The punch/binding machine as claimed in claim 1, wherein the upper die base further comprises two protrusions located on two ends of the upper die base, the body further comprises two sliding slots for the protrusions of the upper die base to slide therein.

9. The punch/binding machine as claimed in claim 1, wherein the punches are locked on the upper die base.

10. The punch/binding machine as claimed in claim 1, wherein the punching module further comprises a punch seat having a plurality of holes corresponding to the punches; the punches are inserted into the holes, and the punch seat is locked on the upper die base.

11. The punch/binding machine as claimed in claim 1, wherein the lower die base has an upper groove and a lower groove on each side thereof, and the area of the upper groove is less than that of the lower groove, the joint element is a bolt with one end being a threaded portion and the other end being a head portion, the joint element passes through the lower groove and the upper groove and is locked on the upper die base by using the threaded portion, and the joint element is movable in the upper groove and the lower groove of the lower die base.

12. The punch/binding machine as claimed in claim 1, wherein each of the resilient elements is a spring, each of the joint elements is a bolt, and each of the resilient elements surrounds each of the joint elements.

13. The punch/binding machine as claimed in claim 1, wherein the number of the punching modules is three.

14. A punching module for a punch/binding machine, comprising:
an upper die base, having a plurality of punches disposed therein;
a lower die base, having at least one hole for the punches to pass through;
two joint elements, respectively connected to two sides of the upper die base and the lower die base; and
two resilient elements, respectively pressing against two sides of the upper die base and the lower die base.

15. The punching module as claimed in claim 14, further comprising a lower die, at least one punch guide plate, and a securing element; the lower die has a plurality of holes corresponding to the punches, the punch guide plate has a plurality of holes corresponding to the punches, the lower die is fixed on the lower die base, and the punch guide plate is fixed on the lower die through the securing element.

16. The punching module as claimed in claim 14, wherein the number of the punch guide plates is two.

17. The punching module as claimed in claim 14, wherein the number of the punch guide plates is three.

18. The punching module as claimed in claim 14, wherein the upper die base further comprises two protrusions located at two ends of the upper die base.

19. The punching module as claimed in claim 14, wherein the punches are locked on the upper die base.

20. The punching module as claimed in claim 14, further comprising a punch seat having a plurality of holes corresponding to the punches, the punches being inserted into the holes, and the punch seat being locked on the upper die base.

21. The punching module as claimed in claim 14, wherein the lower die base has an upper groove and a lower groove on each side thereof, and the area of the upper groove is less than that of the lower groove, the joint element is a bolt with one end being a threaded portion and the other end being a head portion, the joint element passes through the lower groove and the upper groove and is locked on the upper die base by using the threaded portion, and the joint element is movable in the upper groove and the lower groove of the lower die base.

22. The punching module as claimed in claim 14, wherein each of the resilient elements is a spring, each of the joint elements is a bolt, and each of the resilient elements surrounds each of the joint elements.

23. The punching module as claimed in claim 14, wherein the punches are square-shaped.

24. The punching module as claimed in claim 14, wherein the punches are round-shaped.

25. The punching module as claimed in claim 14, wherein the upper die base further includes two screw holes, the screw holes are located on the upper surface of the upper die base for screwing in a bolt, such that it is convenient to take out the punching module.

26. The punching module as claimed in claim 14, wherein the upper die base further includes at least one handle, the handle is disposed on the upper surface of the upper die base, such that it is convenient to take out the punching module.

27. A modular punch/binding machine, comprising:
a transmission device, for receiving an external force;
a first punching module, comprising:
a first upper die base, having a plurality of first punches disposed therein, wherein the transmission device contacts and drives the first upper die base;
a first lower die base, having at least one hole for the first punches to pass through;
two first joint elements, respectively connected to two sides of the first upper die base and the first lower die base; and
two first resilient elements, respectively pressing against two sides of the first upper die base and the first lower die base;
a second punching module, comprising:
a second upper die base, having a plurality of second punches disposed therein, wherein the transmission device contacts and drives the second upper die base;
a second lower die base, having at least one hole for the second punches to pass through;
two second joint elements, respectively connected to two sides of the second upper die base and the second lower die base; and
two second resilient elements, respectively pressing against two sides of the second upper die base and the second lower die base;
a third punching module, comprising:
a third upper die base, having a plurality of third punches disposed therein, wherein the transmission device contacts and drives the third upper die base;
a third lower die base, having at least one hole for the third punches to pass through;
two third joint elements, respectively connected to two sides of the third upper die base and the third lower die base; and
two third resilient elements, respectively pressing against two sides of the third upper die base and the third lower die base; and
a body, having two first bumps, two second bumps, and two third bumps, wherein the first bumps are used to support two sides of the first lower die base, the second bumps are used to support two sides of the second lower die base, and the third bumps are used to support two sides of the third lower die base;
wherein the external force drives the transmission device to simultaneously drive the first upper die base, the second upper die base and the third upper die base to move downward, such that the first punches pass through the holes of the first lower die base, the second punches pass through the holes of the second lower die base, the third punches pass through the holes of the third lower die base; and then after the external force is released, the first resilient elements push the first upper die base away from the first lower die base, the second resilient elements push the second upper die base away from the second lower die base, and the third resilient elements push the third upper die base away from the third lower die base.

28. The punch/binding machine as claimed in claim 27, further comprising a left-side upper cover body and a right-side upper cover body, wherein the body comprises a left-side body and a right-side body, the left-side upper cover body is fixed on the left-side body, and the right-side upper cover body is fixed on the right-side body.

29. The punch/binding machine as claimed in claim 28, wherein the transmission device comprises an input shaft, a left input gear, a right input gear, a left transmission rack, a right transmission rack, a left T-shaped rod, a right T-shaped rod and an input rod, the left input gear and the right input gear are fitted on two ends of the input shaft, two ends of the input shaft are respectively supported by the left-side upper cover body and the right-side upper cover body, one end of the input rod is secured to the input shaft, and the other end of the input rod receives the external force, the left transmission rack is secured to the left T-shaped rod and receives the transmission of the left input gear, the right transmission rack is secured to the right T-shaped rod and receives the transmission of the right input gear, and the bottom surfaces of the left T-shaped rod and the right T-shaped rod are in contact with the upper surfaces of the first upper die base, the second upper die base, and the third upper die base.

30. The punch/binding machine as claimed in claim 29, wherein the left-side upper cover body further comprises a left groove for the left transmission rack to slide therein, and the right-side upper cover body further comprises a right groove for the right transmission rack to slide therein.

31. The punch/binding machine as claimed in claim 28, further comprising an upper cover plate for covering the space between the left-side upper cover body and the right-side upper cover body.

32. The punch/binding machine as claimed in claim 27, wherein the transmission device comprises an input shaft, a left input gear, a right input gear, a left transmission rack, a right transmission rack, a left T-shaped rod, a right T-shaped rod and an input rod, the left input gear and the right input gear are fitted on two ends of the input shaft, one end of the input rod is secured to one end of the input shaft, and the other end of the input rod receives the external force, the left transmission rack is secured to the left T-shaped rod and receives the transmission of the left input gear, the right transmission rack is secured to the right T-shaped rod and receives the transmission of the right input gear, and the bottom surfaces of the left T-shaped rod and the right T-shaped rod are in contact with the upper surfaces of the first upper die base, the second upper die base, and the third upper die base.

33. The punch/binding machine as claimed in claim 27, wherein the first punching module further comprises a first lower die, a first punch guide plate, and a first securing element, and the first lower die has a plurality of holes corresponding to the first punches; the first punch guide plate has a plurality of holes corresponding to the first punches, the first lower die is fixed on the first lower die base, and the first punch guide plate is fixed on the first lower die through the first securing elements.

34. The punch/binding machine as claimed in claim 27, wherein the second punching module further comprises a second lower die, two second punch guide plates, and a plurality of second securing elements, the second lower die has a plurality of holes corresponding to the second punches, the second punch guide plates have a plurality of holes corresponding to the second punches, the second lower die is fixed on the second lower die base, and the second punch guide plates are fixed on the second lower die through the second securing elements.

35. The punch/binding machine as claimed in claim 27, wherein the third punching module further comprises a third lower die, three third punch guide plates, and a plurality of third securing elements, the third lower die has a plurality of holes corresponding to the third punches, the third punch guide plates have a plurality of holes corresponding to the third punches, the third lower die is fixed on the third lower die base, and the third punch guide plates are fixed on the third lower die through the third securing elements.

36. The punch/binding machine as claimed in claim 27, wherein the first upper die base further comprises two first protrusions located at two ends of the first upper die base, and the body further comprises two first sliding slots for the first protrusions of the first upper die base to slide therein.

37. The punch/binding machine as claimed in claim 27, wherein the second upper die base further comprises two second protrusions located at two ends of the second upper die base, and the body further comprises two second sliding slots for the second protrusions of the second upper die base to slide therein.

38. The punch/binding machine as claimed in claim 27, wherein the third upper die base further comprises two third protrusions located at two ends of the third upper die base, and the body further comprises two third sliding slots for the third protrusions of the third upper die base to slide therein.

39. The punch/binding machine as claimed in claim 27, wherein the first punches are locked on the first upper die base, the second punches are locked on the second upper die base, and the third punches are locked on the third upper die base.

40. The punch/binding machine as claimed in claim 27, wherein the first lower die base has a first upper groove and a first lower groove on each side thereof, and the area of the first upper groove is less than that of the first lower groove, the first joint element is a bolt with one end being a threaded portion and the other end being a head portion, the first joint element passes through the first lower groove and the first upper groove and is locked on the first upper die base by using the threaded portion, and the first joint element is movable in the first upper groove and the first lower groove of the first lower die base.

41. The punch/binding machine as claimed in claim 27, wherein the second lower die base has a second upper groove and a second lower groove on each side thereof, and the area of the second upper groove is less than that of the second lower groove, the second joint element is a bolt with one end being a threaded portion and the other end being a head portion, the second joint element passes through the second lower groove and the second upper groove and is locked on the second upper die base by using the threaded portion, and the second joint element is movable in the second upper groove and the second lower groove of the second lower die base.

42. The punch/binding machine as claimed in claim 27, wherein the third lower die base has a third upper groove and a third lower groove on each side thereof, and the area of the third upper groove is less than that of the third lower groove, the third joint element is a bolt with one end being a threaded portion and the other end being a head portion, the third joint element passes through the third lower groove and the third upper groove and is locked on the third upper die base by using the threaded portion, and the third joint element is movable in the third upper groove and the third lower groove of the third lower die base.

43. The punch/binding machine as claimed in claim 27, wherein each of the first resilient elements is a spring, each of the first joint elements is a bolt, and each of the first resilient elements surrounds each of the first joint elements.

44. The punch/binding machine as claimed in claim 27, wherein each of the second resilient elements is a spring, each of the second joint elements is a bolt, and each of the second resilient elements surrounds each of the second joint elements.

45. The punch/binding machine as claimed in claim 27, wherein each of the third resilient elements is a spring, each of the third joint elements is a bolt, and each of the third resilient elements surrounds each of the third joint elements.

46. The punch/binding machine as claimed in claim 27, wherein the first punches are locked on the first upper die base.

47. The punch/binding machine as claimed in claim 27, wherein the second punching module further comprises a second punch seat having a plurality of holes corresponding to the second punches, the second punches are inserted into the holes, and the second punch seat is locked on the second upper die base.

48. The punch/binding machine as claimed in claim 27, wherein the third punching module further comprises a third punch seat having a plurality of holes corresponding to the third punches, the third punches are inserted into the holes, and the third punch seat is locked on the third upper die base.
